(19) United States
(12) Patent Application Publication
(10) Pub. No.: US 2003/0074172 A1
(43) Pub. Date: Apr. 17, 2003

(54) Method and apparatus for a head injury simulation system

(76) Inventors: Michael Ortiz, La Canada, CA (US); Alejandro Mota, Pasadena, CA (US)

Correspondence Address: J.D. Harriman II, COUDERT BROTHERS LLP, 23rd Floor, 333 South Hope Street, Los Angeles, CA, 90071, US

(21) Appl. No.: 10/071,857

(22) Filed: Feb. 6, 2002

Related U.S. Application Data
(60) Provisional application No. 60/266,606, filed on Feb. 6, 2001.

(51) Int. Cl. G06G 7/48

(52) U.S. Cl. 703/11

(57) ABSTRACT

The present invention relates to a head injury simulation system; specifically, the ballistic penetration of the skull by a projectile. In one or more embodiments of the present invention, the cohesive theories of fracture, in conjunction with the explicit simulation of fracture and fragmentation, is applied to finite element simulations of firearm injuries to the human cranium. The simulation explicitly reproduces the impact, the nucleation of fracture, the extension of damage, and the scattering of comminuted fragments. In one embodiment, the bullet-skull impact is obtained with an approximated version of a nonsmooth contact algorithm. In one embodiment, the explicit simulation of fracture nucleation and propagation is achieved by a self-adaptive fragmentation procedure. In one embodiment, the progressive decohesion of fractures is modeled by cohesive elements.

### BACKGROUND OF THE INVENTION

Applicant hereby claims priority to provisional patent application 60/266,606 filed Feb. 6, 2001.

1 . Field of the Invention

The present invention relates to the field of computational modeling of physical processes. Specifically, the present invention relates to a method and apparatus for the simulation of a head injury by a projectile.

2. Background of the Invention

In the U.S., almost one million people suffer from the effects of head injuries every year. More than 400,000 patients with new injuries of the head are admitted to U.S. hospitals each year. Many of these injuries result from firearm-related incidents. Since the late 1950's, firearm deaths have increased dramatically in the United States. In 1988, for example, firearm-related incidents were responsible for 34,000 deaths, making them the eighth leading cause of death in the U.S.. Moreover, for every firearm-related death, there are an additional seven people who sustain non fatal gunshot wounds. Gunshot wounds to the head are the leading or second leading cause of head injury in many U.S. cities. They are also the most lethal of all firearm injuries. It is estimated that gunshot wounds to the head have a greater than 90% fatality rate for U.S. civilians, and at least two thirds of the victims die before reaching a hospital.

Damage Resulting From Firearm-Related Head Injuries

Much of what is known about how penetrating injuries damage the brain and how the damage is best treated comes from studying the many thousands of soldiers who received head injuries during World War II, the Korean War, and the Vietnamese War. The predictors of neurological outcome after a gunshot wound to the head are presently quite primitive and include the Glasgow Coma Scale score, age, presence of low blood pressure or inadequate oxygenation early after injury and dilated non-reactive pupils. The bullet trajectory through the brain has major significance. Bullets that traverse the brainstem, multiple lobes of the brain, or the ventricular system (chambers where cerebrospinal fluid is located) are particularly lethal. Many initial survivors develop uncontrollable intracranial pressure and subsequently succumb.

Most of the available physical evidence of the firearms damage comes from forensic medicine. Statistical analysis of data obtained from direct examination of wounds permits to establish correlations between the gunshot characteristics (speed, angle of impact, bullet caliber and many others) and the damage to the biological tissues. In some cases, a definitive correlation between gunshot data and induced damage has not been established.

Treatment of Firearm-Related Head Injuries

Virtually all cranial gunshot victims are aggressively resuscitated upon initial arrival at the hospital. If a patient's blood pressure and oxygenation can be maintained, an urgent CT scan of the brain is obtained. The decision to proceed with operative management of the gunshot wound is based on three factors: the level of consciousness (GCS), the degree of brainstem neurological function and the findings on the CT scan.

There is a lack of a simulation system to assist physicians with operative management in a variety of ways, including: plotting maps of damage to the brain, thus helping pin-point the location of hematomas and other lesions; and by mapping likely trajectories of slugs, especially in the absence of a exit wound.

Forensics Background

Firearm wounds to the cranium are characterized by several parameters, e.g., the pattern and the angle of entrance and exit of the projectile, the range of fire, the impact speed and the caliber of the bullet and others. FIG. 1 is an illustration of a skull with an entrance wound on the right parietal bone and an exit wound on the left parietal bone.

Wounds produced by high-speed bullet impacting the skull under high angle are generally round or oval, with a sharp well defined edge. When the bullet penetrates in thicker bones, as the mandible, the wound can assume unusual forms, like keyhole-shaped as shown in the FIG. 1.

Experimental gun shots on skull bone show that the bone is easily punctured, generally without showing extended radial cracks typical of blunt trauma. Cranial cracks radiating from localized bullet wounds are sometimes observed in low-speed (less than 600 m/s) incidents, typically only in the entrance wound. Entrance wounds are generally characterized by internal beveling, although external beveling has been reported. External beveling is common in exit wounds, but seldom internal beveling may also be observed. A scarce number of observations is available for wounds determined by a trajectory of the projectile tangential to the cranium. Such wounds frequently show a keyhole shape, sometimes with both internal and external beveling.

There is a limited insight into the correlation between wound dimensions and bullet characteristics. A correlation between bullet caliber and wound dimensions is of practical interest when, for instance, the bullet is absent or lost. Other features, as the ratio between entrance wound area and exit wound area, are commonly well defined and accepted.

Table 1, below, tabulates the maximum, minimum, and average diameters for entrance wounds. In table 1, N is the number of observed wounds, μ is the mean, σ the standard deviation, and min and max are the minimum and maximum wound diameter for a given bullet caliber.

TABLE 1

| Caliber | | μ | σ | min | max |
|---|---|---|---|---|---|
| (in. mm) | N | (mm) | (mm) | (mm) | (mm) |
| Maximum | | | | | |
| .22, 5.59 | 37 | 6.76 | 1.27 | 5.6 | 11.5 |
| .25, 6.35 | 5 | 6.72 | 0.66 | 6.0 | 7.5 |
| .32, 5.13 | 6 | 8.67 | 1.52 | 6.6 | 10.9 |
| .38, 9.65 | 25 | 11.00 | 2.33 | 8.7 | 17.4 |
| Minimum | | | | | |
| .22, 5.59 | 37 | 8.49 | 2.23 | 5.9 | 16.7 |
| .25, 6.35 | 4 | 8.58 | 1.64 | 6.3 | 10.0 |
| .32, 8.13 | 6 | 10.77 | 2.37 | 7.0 | 15.0 |
| .38, 9.65 | 23 | 12.88 | 3.42 | 9.4 | 22.0 |
| Average | | | | | |
| .22, 5.59 | 16 | 7.62 | 1.68 | 5.6 | 10.9 |
| .25, 6.35 | 8 | 7.11 | 0.94 | 5.4 | 9.1 |
| .38, 9.65 | 11 | 11.68 | 1.75 | 8.1 | 18.2 |

Gunshot wounds to unprotected head cause immediate incapacitation, especially in view of the high-energy bullets used by most modern firearms. Lack of immediate incapacitation is found only under special circumstances. For military personnel during battlefield conditions, it has been proved that helmets provided a significant reduction of damage.

Constitutive Behavior of Bone Tissue

Bone is a hard, but brittle, tissue and is relatively light per unit volume. Bone tissue is composed by cells (osteocytes) and by an intracellular matrix, partially organic (collagen fibers) and partially inorganic (minerals). Cells maintain the bone matrix, which has the function to support the weight of other tissues and protect underlying tissues.

The main components of the bone matrix are calcium phosphate (71%), collagen (19%), water (8%) and other organic materials (proteins, polysaccharides and lipids). The bone matrix is a combination of collagen microfibers (diameter from 100 nm to 2000 nm) and deposited minerals. Collagen is a soft, ductile material, and its behavior is close to polymers. Collagen microfibers provide the strength and the flexibility of the bone tissue. Calcium phosphate, in the form of crystallized hydroxiapatite or amorphous calcium phosphate, is a kind of ceramic, stiff and brittle, and is responsible for the hardness of the bone.

Bones have two main structures, compact and spongy (cancellous). FIG. 2a is an illustration of a compact bone and FIG. 2b is an illustration of cancellous bone. Compact bone is organized into individual functional units called osteons, a fibrous structure clearly visible in micrographs. Each osteon is composed of concentric layers of mineral-containing fibers called lamellae. Spongy bone has a characteristic porous structure defined by a cellular network of simple bone elements called trabeculae. Traveculae have the shape of “rods” and “plates”. Under high stress simulation, spongy bones grow mainly plate trabeculae; rod trabeculae characterize low stress zones.

Bones are classified in long, flat and irregular bones; they are composed of both spongy and compact bone. FIG. 3 is an illustration of a structure of a flat skull bone. A flat or “membrane” bone of a skull is composed in a sandwich-like fashion of an outer layer of compact bone (outer table), a middle layer of spongy bone (diploe) and an inner layer of compact bone (inner table). The ratio between the three layers thickness is variable.

The constitutive behavior of bone is the result of the complementary properties of collagen and calcium phosphate. The mechanical properties are related to the relative concentration of the two main components and to the orientation of the collagen fibers in the microstructure. As almost all the biological tissues, the bone shows a strong rate dependency.

FIG. 4 shows a typical set of human bone stress-strain curves for different strain rates. At low strain rates, the constitutive behavior is dominated by the organic component (collagen), and bone behaves as a relatively soft (low stiffness), ductile material (failure at relatively high strains). At higher strain rates, the mineral component (calcium phosphate) increases his influence, and the bone shows higher stiffness and brittleness. At very high strain rates, the inorganic component fully characterizes the mechanical behavior: bone becomes stiff and brittle and failure occurs at relatively low strains.

A complete description of the injuries to the head tissues produced by a projectile would need to account for mechanical and neurological damage on the involved organs. Computational mechanics offers a non-invasive means of characterizing impact injuries by mechanical parameters. Statistical studies would receive a substantial improvement from the availability of the simulation.

A mechanical-based computational simulation of firearm-related head injuries is necessary to help in operative management and post-traumatic care. A simulation system could also aid forensic medicine to predict the fatality of wounds on a mechanical basis and to understand the sequence of damaging events in a firearm incident. Additionally, it would also improve the design of protective gear, such as helmets, for defense purposes.

### SUMMARY OF THE INVENTION

The present invention relates to a head injury simulation system; specifically, the ballistic penetration of the skull by a projectile. In one or more embodiments of the present invention, the cohesive theories of fracture, in conjunction with the explicit simulation of fracture and fragmentation, is applied to finite element simulations of firearm injuries to the human cranium. The simulation explicitly reproduces the impact, the nucleation of fracture, the extension of damage, and the scattering of comminuted fragments. In one embodiment, the bullet-skull impact is obtained with an approximated version of a nonsmooth contact algorithm. In one embodiment, the explicit simulation of fracture nucleation and propagation is achieved by a self-adaptive fragmentation procedure. In one embodiment, the progressive decohesion of fractures is modeled by cohesive elements.

### BRIEF DESCRIPTION OF THE DRAWINGS

These and other features, aspects and advantages of the present invention will become better understood with regard to the following description, appended claims and accompanying drawings where:

FIG. 1 is an illustration of a skull with an entrance wound on the right parietal bone and an exit wound on the left parietal bone.

FIG. 2a is an illustration of a compact bone.

FIG. 2b is an illustration of a cancellous bone.

FIG. 3 is an illustration of a structure of a flat skull bone.

FIG. 4 shows a typical set of human bone stress-strain curves for different strain rates.

FIG. 5A is a flowchart of one embodiment of the present invention.

FIG. 5B is an illustration of the analytical components of the step of calculating the dynamics of the projectile and target in accordance with one embodiment of the present invention.

FIG. 5C is a flowchart of the contact algorithm according to one embodiment of the present invention.

FIG. 5D is a flowchart of the fragmentation algorithm according to one embodiment of the present invention.

FIG. 6 is a block diagram illustrating an implementation of Newmark's explicit time stepping algorithm in accordance with one embodiment of the present invention

FIG. 7 is an illustration of the preliminary proximity search in accordance with one embodiment of the present invention.

FIG. 8 is an illustration of a 3D Body with a cohesive surface.

FIG. 9 is a diagram of the irreversible cohesive law, with linearly decreasing envelop, in accordance with one embodiment of the present invention.

FIG. 10 is an illustration of initial finite element mesh generated in one of the embodiments of the present invention.

FIG. 11 is an illustration of front view/external side simulation snapshots of deformed configuration at 0, 11, 22, and 33 microseconds after an impact generated in one of the embodiments of the present invention.

FIG. 12 is an illustration of brain view/brain side simulation snapshots of deformed configuration at 0, 11, 22, and 33 microseconds after an impact generated in one of the embodiments of the present invention.

FIG. 13 is an illustration of simulation snapshot of final configuration without bullet and flying fragments generated in one of the embodiments of the present invention.

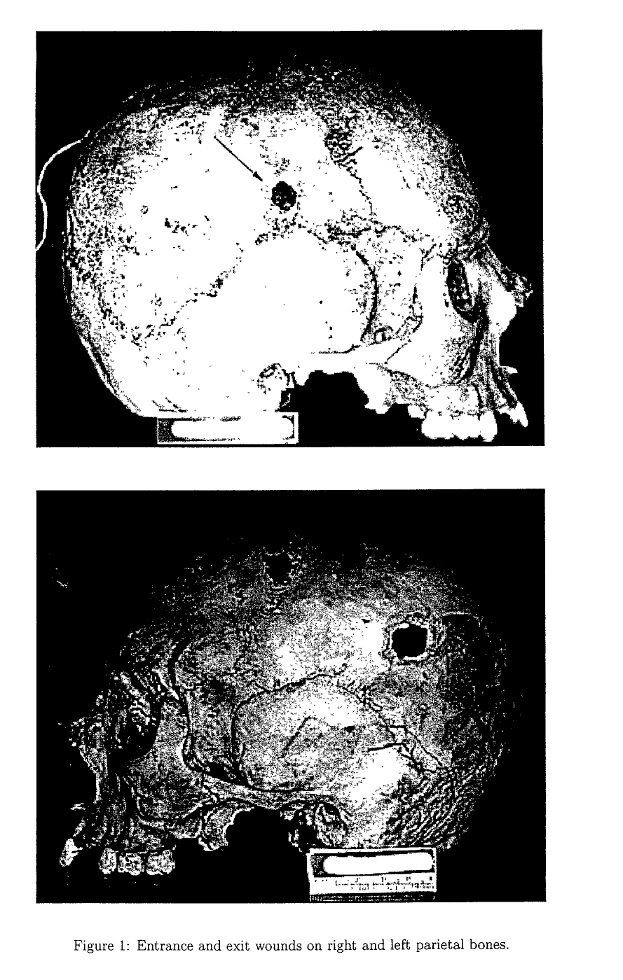

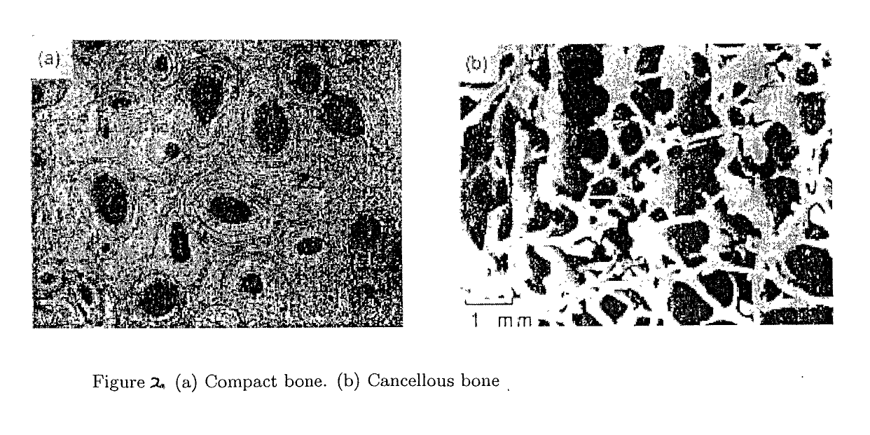

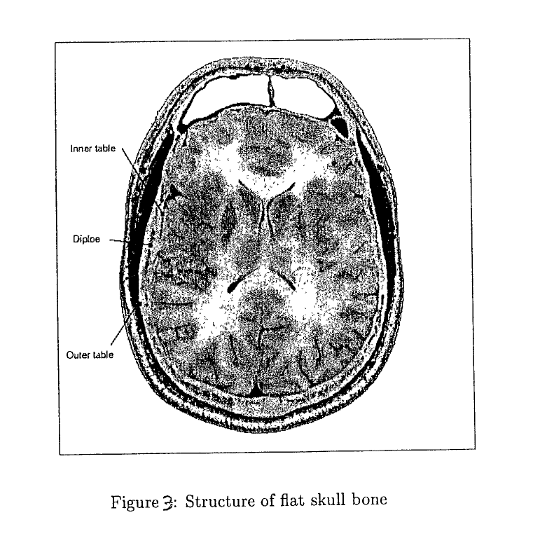

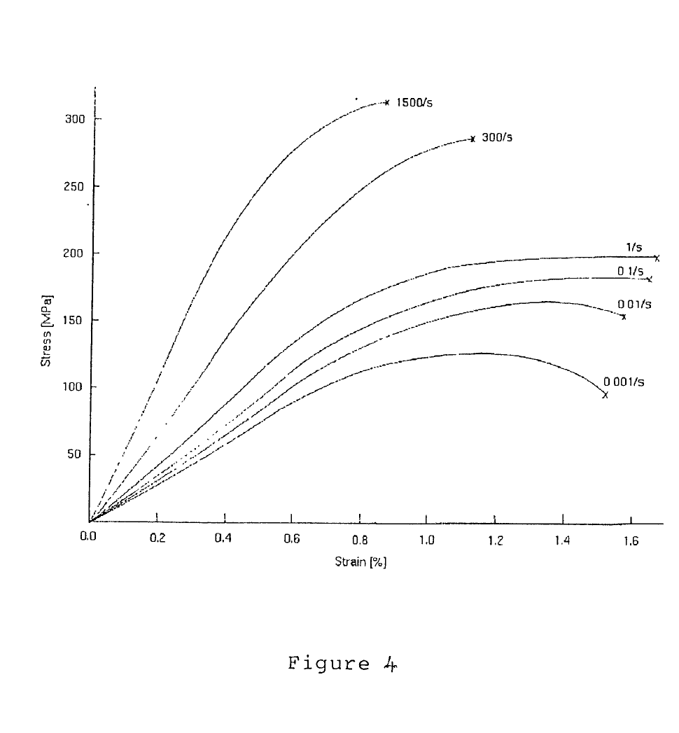

### DETAILED DESCRIPTION OF THE INVENTION

The invention is a method and apparatus for a head injury simulation system (HISS). In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

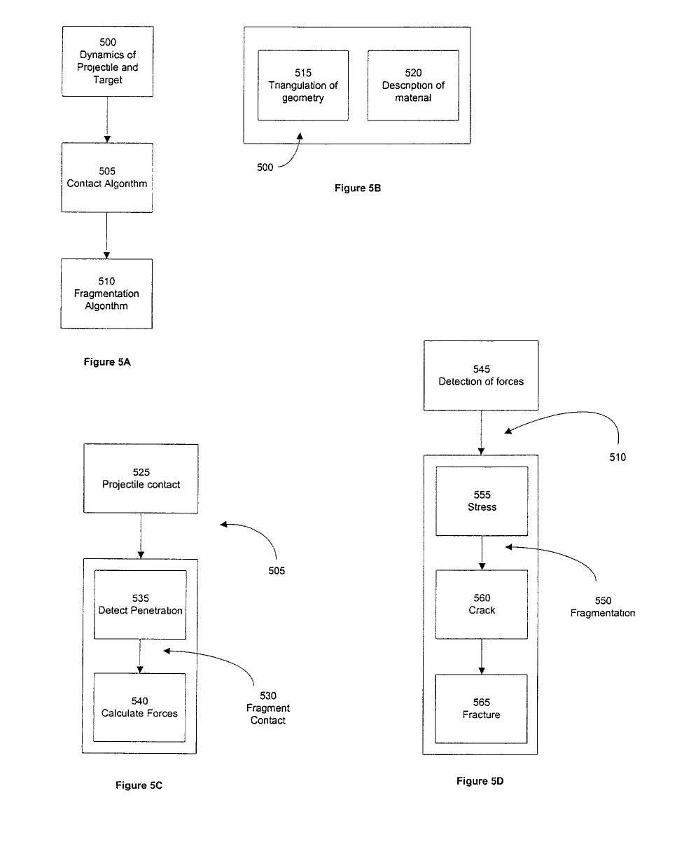

FIG. 5A is an illustration of one of the embodiments of the present invention. The HISS algorithm comprises three steps. In step 500, the dynamics of the projectile and target are calculated. In step 505, the forces of the projectile stressing the bone is simulated in a contact algorithm. In step 510, the fracture of the bone resulting from the projectile contact is simulated in a fragmentation algorithm.

Dynamics of Projectile and Target

FIG. 5B illustrates the components of one embodiment of the dynamics calculation step 500. Dynamics calculation step 500 is comprised of triangulation of geometry determination block 515 and a material description block 520. Several parameters characterize the triangulation of geometry 515. In one of the embodiments of the present invention, these parameters include a pattern and an angle of entrance and exit of a projectile, a range of fire, an impact speed and a caliber of a bullet. In one simulation of the present invention, a bullet has an impact speed of 1000 m/s and the caliber of the projectile was 9 mm.

Several parameters characterize the description of the material block 520. In one or more embodiments, several assumptions are made to simplify a simulation of the occurrence of a head injury. Although the ratio between the three bone layers is variable, modeling of the layered structure requires an extremely fine mesh.

In one embodiment the ratio between the diploe and the inner/outer tables is estimated to be of value one. A parietal bone is assumed homogeneous and isotropic. The elastic properties chosen for a “homogenized” bone are the average of the values for compact and spongy bones.

In consideration of the high strain rates involved, a bone is assumed to be elastic in nature, obeying a neohookean elasticity model, up to a traction limit. The steel projectile is assumed to be unlimited elastic. The elastic properties for a projectile and a skull are collected in Table 2. The material properties for the cohesive constitutive law for a bone are shown in Table 3.

TABLE 2

| Material | E (GPa) | ν | ρ (kg/m³) |
|---|---|---|---|
| Steel | 201.0 | 0.30 | 7800.0 |
| Bone | 10.0 | 0.10 | 1700.0 |

TABLE 3

| G_{c} (N/m) | σ_{c} (MPa) | δ_{c} (μm) | β |
|---|---|---|---|
| 90.0 | 60.0 | 3.0 | 1.0 |

Contact Algorithm

FIG. 5C illustrates a flowchart of the contact algorithm 505 of one of the embodiments of the present invention. The first step of a contact algorithm 505 is a simulation of the contact of the projectile with bone 525. The second step of contact algorithm 505 is a fragment contact algorithm 530. Fragment contact algorithm 530 comprises the steps of projectile penetration detection 535 and force calculation 540.

Contact algorithm 505 is simulated through a dynamic finite element analysis. The space-discretized equations of motion are explicitly integrated in time by Newmark's time-stepping algorithm.

In one embodiment, both a projectile contact step 525 and a fragment contact step 530 are simulated in a nonsmooth analysis. In a nonsmooth contact situation the corners and ridges of the particles are involved in the analysis and the normal to the colliding surfaces is not univocally defined.

Contact situations arise when free trajectories of bodies in space are restricted by the presence of obstacles (i. e. fixed surfaces or other bodies). In one of the embodiments of the present invention, these restrictions are expressed as algebraic inequalities of the coordinates identifying the configuration of the bodies. These inequalities are called impenetrability constraints. The set of bodies trajectories that do not violate any impenetrability constraint is called admissible set C. In one embodiment, C is the set of all the one-to-one deformation mappings φ for deformable bodies. Similar definitions apply to discretized systems and the notation φ is also used for a discretized deformation mapping and C for the set of admissible discretized configurations.

Under finite element discretization, impenetrability constraints are described by inequalities 9α(φ)≧0 of the nodal displacements. If N is the number of constraints, an alternative way to define the admissible set C is to include all the discretized deformation mappings satisfying the N non-negativity conditions:

φεC⇄g_{α}(φ)≧0, α=1, . . . , N (1)

From an energetic point of view, contact may be accounted for augmenting the mechanical energy of the system with an additional term expressing the contact energy. The contact energy contribution is called indicator function I_{C} and is defined as:

$${I}_{C} ( ϕ ) = \{ \begin{matrix}0 , & if ϕ ∈ C , \\ ∞ , & otherwise\end{matrix} \qquad ( 2 )$$

Thus the contact forces follow as the generalized gradient of the indicator function:

F^{con}(φ)=∂I_{C}(φ) (3)

The generalized gradient ∂I_{C}(φ) reduces to ordinary derivative in smooth situations.

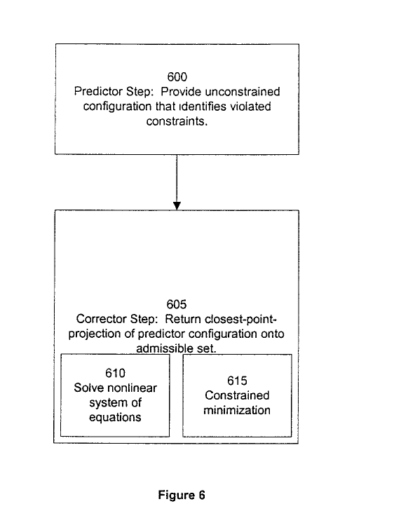

In one of the embodiments of the present invention, Newmark's time-stepping algorithm is implemented as a predictor/corrector contact algorithm. FIG. 6 is a block diagram illustrating an implementation of Newmark's explicit time-stepping algorithm in accordance with one of the embodiments of the present invention.

A predictor step 600 provides an unconstrained configuration that identifies the violated constraints. A corrector step 605 returns a closest-point-projection of a predictor configuration onto an admissible set C. In one of the embodiments of the present invention, a corrector step 605 is implemented by solving a non-linear system of equation 610. In another embodiment of the present invention, the corrector step 605 is implemented by a constrained minimization 515.

In one of the embodiments of the present invention, a predictor/corrector implementation of Newmark's explicit time-stepping algorithm is modified by the adoption of an approximate procedure based on a penalty approach. This embodiment enhances the processing speed when numerous constraints are involved. For example, up to 100,000 constraints are violated simultaneously as a consequence of the proliferation of fragments in brittle materials. In this embodiment, the indicator function is approximated as the sum of quadratic terms, one for each violated constraint:

$${I}_{C} ( ϕ ) \approx \frac{1}{2} p {\sum }_{α = 1}^{N} {g}_{α}^{2} ( ϕ ) ,$$

(4)

where p is a penalty parameter. The contact forces are approximated in the following equation:

$${F}^{con} ( ϕ ) \approx p {\sum }_{α = 1}^{N} {g}_{α} ( ϕ ) ∇ {g}_{α} ( ϕ ) \qquad ( 5 )$$

The semi-discrete equation of motion in the presence of contact is:

M\ddot{φ}+F^{int}(φ)+F^{con}(φ)=F^{ext} (6)

where M is the lumped mass matrix.

Newmark's time stepping algorithm may be rewritten by separating the contribution of contact from the other acceleration terms:

$$\begin{matrix}{ϕ}_{n + 1} = {ϕ}_{n} + Δ t {v}_{n} + Δ {t}^{2} [ ( \frac{1}{2} - β ) {a}_{n} + β {a}_{n + 1}^{int} ] - \frac{Δ {t}^{2}}{2} {a}_{n + 1}^{con} ( {ϕ}_{n + 1} ) & ( 7 ) \\ {v}_{n + 1} = {v}_{n} + Δ t [ ( 1 - γ ) {a}_{n} + γ {a}_{n + 1}^{int} - {a}_{n + 1}^{con} ( {ϕ}_{n + 1} ) ] & ( 8 ) \\ {a}_{n + 1} = {M}^{- 1} [ {F}_{n + 1}^{ext} - {F}^{int} ( {ϕ}_{n + 1} ) - {F}^{con} ( {ϕ}_{n + 1} ) ] & ( 9 )\end{matrix}$$

Velocities are denoted by ν and accelerations by α. A constant time step Δt is assumed. The index n denotes the quantities relevant to time step tₙ. The contact accelerations are evaluated at the time step tₙ₊₁, as is required for the robustness of the contact algorithm. The contact accelerations are defined as:

αₙ₊₁^{con}(φₙ₊₁)=−M⁻¹F^{con}(φₙ₊₁) (10)

and the internal accelerations are defined as:

αₙ₊₁^{int}(φₙ₊₁)=M⁻¹[F^{ext}−F^{int}(φₙ₊₁)] (11)

In an explicit version of the algorithm, setting β=0. Eqs. (7-8) can be written as the sum of a predictor term and a corrector term:

$$\begin{matrix}{ϕ}_{n + 1}^{pre} = {ϕ}_{n} + Δ {tv}_{n} + \frac{Δ {t}^{2}}{2} {a}_{n} , {v}_{n + 1}^{pre} = {v}_{n} + Δ t ( 1 - γ ) {a}_{n} & ( 12 ) \\ {ϕ}_{n + 1} = {ϕ}_{n + 1}^{pre} - \frac{Δ {t}^{2}}{2} {a}_{n + 1}^{con} ( {ϕ}_{n + 1} ) , \\ {v}_{n + 1} = {v}_{n + 1}^{pre} + Δ t [ γ {a}_{n + 1}^{int} - {a}_{n + 1}^{con} ( {ϕ}_{n + 1} ) ] & ( 13 )\end{matrix}$$

where φₙ₊₁^{pre} and νₙ₊₁^{pre} are the predictor for displacements and velocities respectively. The contact effects are included in the corrector term only. A constrained minimization provides the corrector configuration φₙ₊₁; thus the contact accelerations can be evaluated by (13a) and used to update the velocities (13b). Alternatively, the contact forces in the predictor configuration are estimated using equation (5), and then equation (13) gives the approximate corrector configuration, in a computationally inexpensive form.

The impenetrability constraints are selected based on one or more assumptions. A common assumption follows the observation that when two bodies overlap, their boundaries intersect. In one of the embodiments of the present invention, the interpenetration between bodies can be therefore detected by checking intersections between portions of their boundaries. In another embodiment of the present invention, under a finite element triangularization, the search is done evaluating the intersection of pairs of spatial triangles. The level of interpenetration can be given by a suitable measure, i.e. an overlapping volume or a distance between two points.

In one of the embodiments of the present invention, all possible triangular face pairs comprising the boundaries of discretized bodies are verified for intersection. In another embodiment of the present invention, a preliminary proximity search is used to reduce the number of intersection tests.

For each boundary triangle, a list of closest triangles is built after a predefined number of time steps. The selection criterion to add a triangle to the list of an other triangle is based on the distance between the two circumcenters:

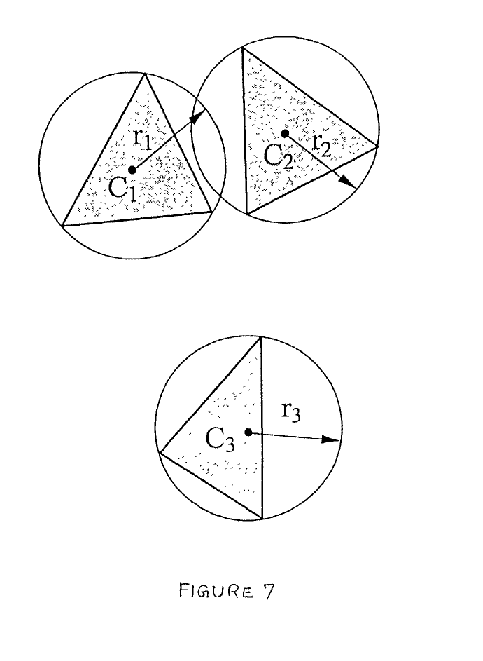

d_{c}_{ᵢ},_{c}_{ⱼ}=∥φ_{c}_{ᵢ}−φ_{c}_{ⱼ}∥≦(rᵢ+rⱼ) (14)

in which d_{c}_{ᵢ},_{c}_{ⱼ} is the distance between the circumcenters Cᵢ and Cⱼ, and rᵢ and rᵢ are the radii of the corresponding circumcircles. The proximity search process is illustrated in FIG. 7. C₁, C₂, and C₃ are there circumcircles of radius r₁, r₂, and r₃ respectively. At each time step, only the closest pairs of triangles are checked for intersection. C₁ and C₂ are the closest two circumcircles and is check whether they intersect each other.

Fragmentation Algorithm

FIG. 5D illustrates a flowchart of the fragmentation algorithm 510 in one of the embodiments of the present invention. The first step of fragmentation algorithm 510 is to detect forces 545. The second step of fragmentation algorithm 510 is to simulate a fragmentation of a bone 550. Bone fragmentation step 550 comprises three sub-steps: a stress analysis 555, a crack analysis 560 and a fracture analysis 565.

Cohesive theories of fracture describe the cracks on a bone as pairs of surfaces whose relative opening is resisted by cohesive forces. Cohesive theories allow the evolution of cracks independently of the constitutive behavior of the bulk. In one of the embodiments of the present invention, the fragmentation algorithm 510 is based on cohesive models embedded in surface-like cohesive elements.

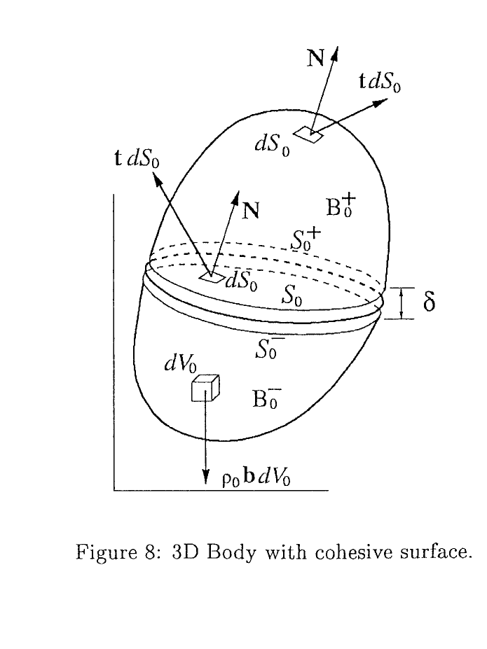

The power of a system with cohesive surfaces includes an additional term accounting for the work-conjugate cohesive quantities, i.e. the displacement jump across the cohesive surface and the cohesive traction. FIG. 8 is an illustration of a 3D body with cohesive surface. Under finite element discretization, cohesive elements give an additional contribution to the internal forces F^{int}(φ) in the semi-discrete equation of motion (6).

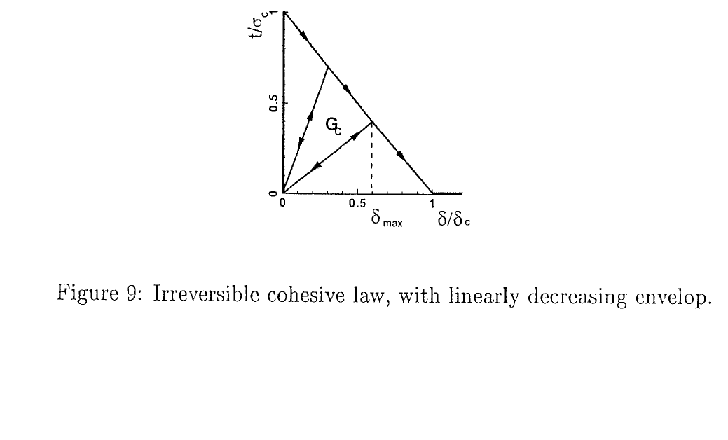

The irreversible cohesive law implemented in one embodiment of the present invention is illustrated in FIG. 9. The irreversible cohesive law is expressed in terms of effective quantities, obtained by weighting the normal and tangential components to the cohesive surface. A cohesive energy density per unit of undeformed area φ is defined as:

φ=φ(δ,q;n) (15)

where δ the displacement jump across the cohesive surface, q a suitable collection of internal variables and n the normal to the deformed cohesive surface. The cohesive law follows from the thermodynamics laws:

$$t = \frac{\partial φ ( δ , q ; n )}{\partial δ} . \qquad ( 16 )$$

A scalar effective opening displacement is also defined as:

δ=\sqrt{α²δ²_{S}+δ²ₙ} (17)

where the normal and tangential components of the opening displacements on the cohesive surface are defined as:

δₙ=δ·n, δ_{S}=|δ_{S}|=|δ−δₙn | (18)

The parameter β assigns different weights to the two displacement components. Assuming that φ is function of the effective δ, the cohesive law can be written as:

$$t = \frac{\partial φ}{\partial δ} ( δ , q ) \qquad ( 19 )$$

Thus the effective cohesive traction is:

t=\sqrt{β⁻²|t_{S}|²+tₙ²} (20)

where tₙ and t_{S} are the normal and tangential components. The cohesive traction is obtained as:

$$t = \frac{t}{δ} ( {β}^{2} {δ}_{S} + {δ}_{n} n ) . \qquad ( 21 )$$

In FIG. 9, σ_{c} is the cohesive traction limit and δ_{c} is the critical opening displacement.

The corresponding critical energy release rate is:

$${G}_{c} = \frac{1}{2} {σ}_{c} {δ}_{c} . \qquad ( 22 )$$

In one of the embodiments of the present invention, the formation of fracture surfaces is simulated with an automatic fragmentation procedure. The simulation begins with a fully coherent mesh, and assume that all the interfaces between adjacent finite elements are potential cohesive surfaces. The fragmentation procedure adaptively updates the discretized topology by inserting cohesive elements at high stress interfacial surfaces. The insertion criterion is based on the achievement of a maximum value for effective traction:

t=\sqrt{tₙ²+β⁻²t_{S}²}≧σ_{c} (23)

where δ_{c} is the cohesive strength of the material. Using the adaptive remeshing, cracks are allowed to nucleate, grow, branch and coalesce, eventually forming fragments.

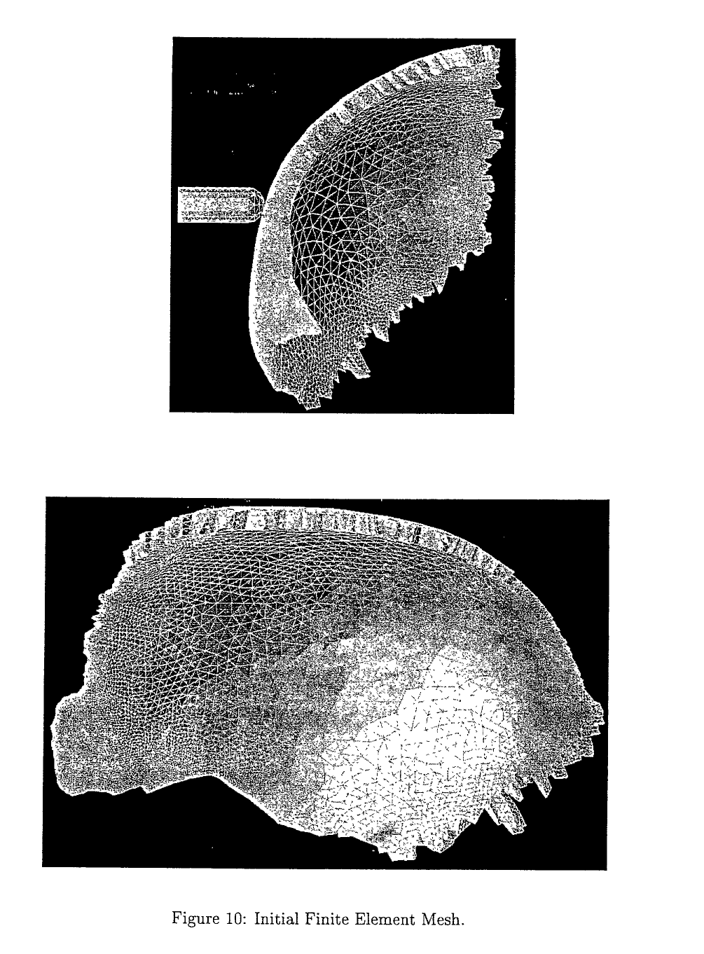

FIG. 10 is an illustration of initial mesh generated in the numberical simulation in one of the embodiments of the present invention. The model is discretized with 10-nodes quadratic tetrahedra, initially coherent; the number of nodes and elements for a skull and a projectile used in one of the embodiments of the present invention is shown in table 4.

TABLE 4

| | Nodes | Elements |
|---|---|---|
| Bullet | 3197 | 2016 |
| Bone | 102981 | 51797 |
| Total | 106178 | 53813 |

In one simulation of the present invention, a bullet has an impact speed of 1000 m/s and the caliber of the projectile was 9 mm. The penalty parameter p for the evaluation of the contact forces was set to 10¹⁵. The value 10¹⁵ is chosen to prevent interpenetration and to control the magnitude of the contact forces. The impact between a bullet and a skull is completed in about 30 μs.

The analysis was interrupted once a projectile had completely crossed a bone's thickness. An average time step used by an explicit integration was 3×10⁻⁴ μs. A contact was verified every 10 time steps, the proximity list rebuilt every 100 time steps, and the fragmentation procedure applied every 1000 time steps. In this time interval, the kinetic energy of the projectile transforms into elastic deformation of the bone tissue, and the stress inside the skull reaches high values also in zones far from the collision area. the nest fragmentation check detects several distant interfaces where the effective traction satisfies the insertion criterion (16). Use of a penalty version of the nonsmooth contact algorithm introduces an additional approximation.

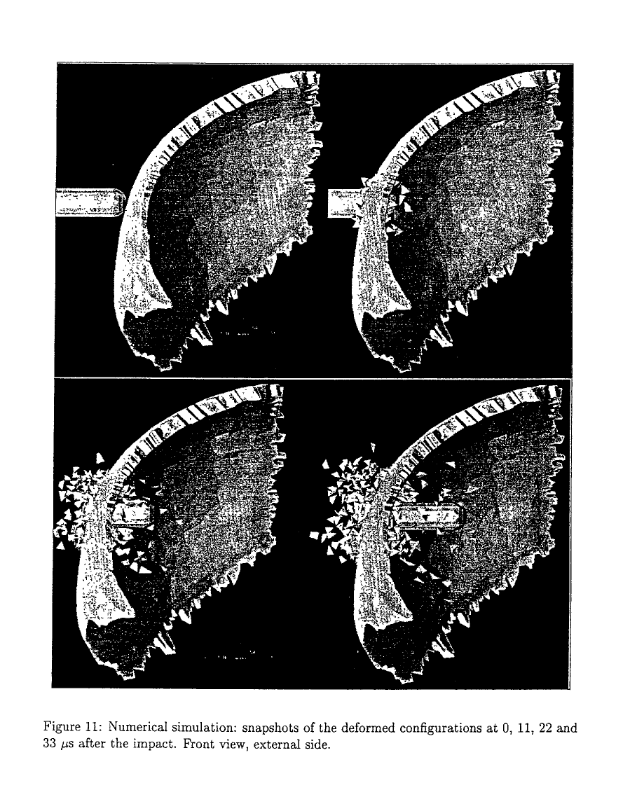

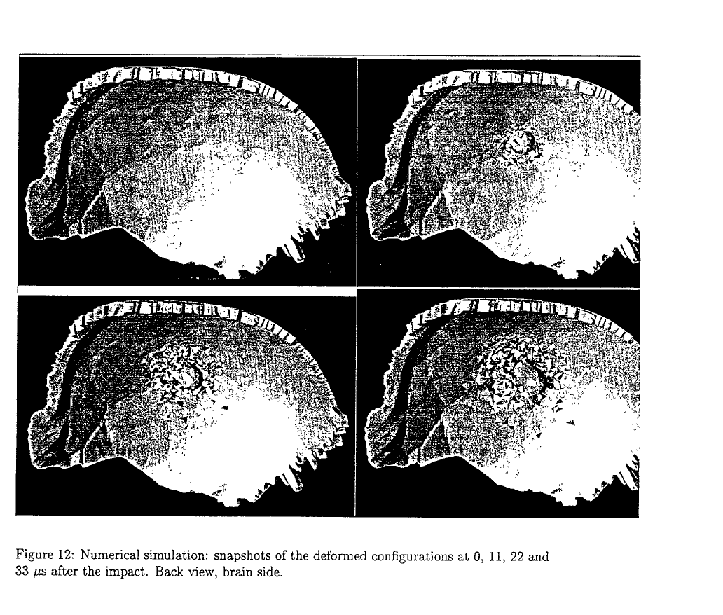

FIG. 11 is an illustration of front view/ external side simulation snapshots of deformed configuration at 0, 11, 22, and 33 microseconds after an impact. FIG. 12 is an illustration of brain view/brain side simulation snapshots of deformed configuration at 0, 11, 22, and 33 microseconds after an impact. The fragments are expelled both forwards and backwards with respect to the trajectory of the bullet.

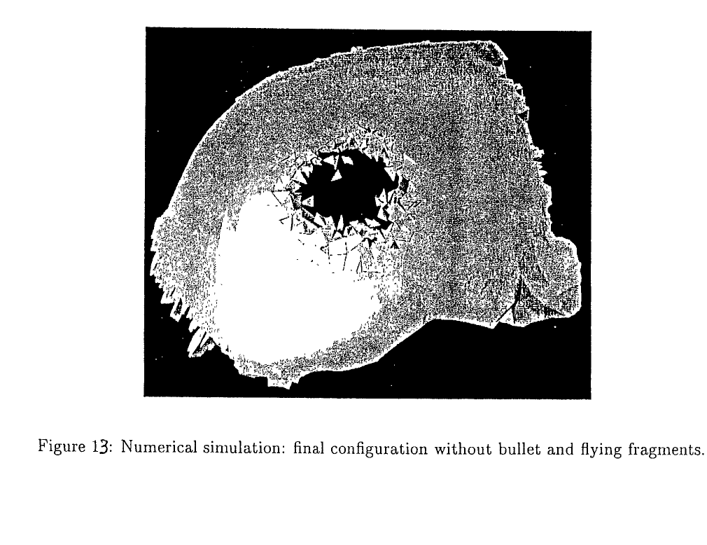

FIG. 13 is an illustration of simulation snapshot of final configuration without bullet and flying fragments. The damage is localized in a circular wound, in agreement with forensic observation. The present invention provides a unique tool for investigating the mechanics of a firearm injuries, including the effect of caliber, trajectory, and speed on the geometry and severity of the injury. The data obtained from the simulation can also be used for elucidating the effectiveness of protective gear such as helmets.

Thus, a method and apparatus for a head injury simulation system is described in conjunction with one or more specific embodiments. The present invention provides the ability to derive a sound mechanistic as opposed to a merely statistical-understanding of traumatic head injury leading to improvements in operative management and post-traumatic care. The present invention simulates a severe heard injury under conditions arising in vehicular accidents in order to validate clinical findings and allow theoretical biomechanical modeling for design of future occupant protection system. Finally, the present invention may assist defendants and insurance companies during personal injury litigation by providing a basis for expert witness, including injury and accident reconstruction and failure analysis. Although the present invention has been described in considerable detail with regard to the preferred versions thereof, other versions are possible. The invention is defined by the claims and their full scope of equivalents.

1. A method for simulating the impact of a projectile with a bone, comprising:
determining the dynamics of said projectile and said bone;
calculating the contact forces of said projectile and said bone; and
calculating the fragmentation of said bone.

2. The method of claim 1, wherein the step of determining the dynamics is comprised of the steps of:
triangulating the geometry of said projectile with respect to said bone; and
describing the properties of said projectile and said bone.

3. The method of claim 2, wherein the step of calculating the contact forces further comprises the use of nonsmooth contact analysis.

4. The method of claim 3, wherein the step of calculating the contact forces further comprises the use of Newmark's explicit time stepping algorithm is to calculate contact forces in discrete time steps.

5. The method of claim 4, wherein the implementation of Newmark's explicit time stepping algorithm is comprised of the steps of:
predicting an unconstrained configuration that identifies violated constraints; and
returning the closest-point-projection of the predictor configuration onto an admissible set.

6. The method of claim 5, wherein the implementation of Newmark's explicit time stepping algorithm further comprises the adoption of a penalty parameter in the predicting step.

7. The method of claim 6, wherein the step of calculating the fragmentation of said bone further comprises:
applying an irreversible cohesive law to said bone;
applying an irreversible cohesive law to cracks in said bone as said cracks develop; and
applying an irreversible cohesive law to bone fragments as said fragments develop.
